(19) United States
(12) Patent Application Publication
(10) Pub. No.: US 2010/0225798 A1
(43) Pub. Date: Sep. 9, 2010

(54) DIGITAL PHOTOGRAPHING DEVICE, METHOD OF CONTROLLING THE SAME, AND COMPUTER-READABLE STORAGE MEDIUM FOR EXECUTING THE METHOD

(76) Inventor: An-seok Lim, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(21) Appl. No.: 12/719,143

(22) Filed: Mar. 8, 2010

(30) Foreign Application Priority Data
Mar. 9, 2009 (KR) 10-2009-0019857

(51) Int. Cl. H04N 5/222

(52) U.S. Cl. 348/333.05; 348/E05.022

(57) ABSTRACT

A method of controlling a digital photographing device is provided. In the digital photographing device, in a display mode, at least one set display value is set. The method includes displaying a first image file, and in response to a direction key signal, displaying a second image file while the set display value is maintained.

### CROSS-REFERENCE TO RELATED PATENT APPLICATION

This application claims the benefit of Korean Patent Application No. 10-2009-0019857, filed on Mar. 9, 2009, in the Korean Intellectual Property Office, the entire contents of which is incorporated herein by reference.

### BACKGROUND OF THE INVENTION

1. Field of the Invention

The present invention relates to a digital photographing device capable of displaying captured images, a method of controlling the same, and a computer-readable storage medium for storing a computer program with which the method is executed.

2. Description of the Related Art

Digital photographing devices include display units that display a captured image and provide a user interface. Even without additional operations involving a computer, users can view images immediately after they are captured through a display unit of a digital photographing device. In addition, display units provide a user interface that is perceivable and easy to use.

When captured images are displayed using digital photographing devices, users can set at least one display mode. For example, digital photographing devices can display image files with an enlarged size. Providing the user the ability to conveniently view captured images with different enlargement sizes may increase the value of the digital photographing device to the user.

### SUMMARY OF THE INVENTION

An objective of the present invention is to display a previous or next image files while set display values are maintained in response to a direction key signal input by a user.

Another objective of the present invention is to allow a user to input a direction key signal so as to select an operation for displaying a previous or next image files while current set display values are maintained or an operation for manipulating a display state of the currently displayed image file.

According to an aspect of the present invention, there is provided a method of controlling a digital photographing device capable of setting at least one set display value in a display mode, the method including: displaying a first image file; and displaying a second image file while the set display value is maintained, in response to a direction key signal.

The set display value may be an enlargement ratio by which an image file is displayed with enlarged size, wherein the displaying a first image file displays the first image file with the enlarged size by a first enlargement ration, and the displaying a second image file displays the second image file with the enlarged size by the first enlargement ratio.

The method may further include determining a state selected by a first control signal; and when the first control signal has had a first state, moving a display region in the displayed first image file with the enlarged size, in response to the direction key signal, the displaying a second image file is performed when the first control signal has had a second state.

According to another aspect of the present invention, there is provided a method of controlling a digital photographing device, the method including: displaying a main image of a first image file with enlarged size by a first enlargement ratio; and displaying a main image of a second image file with enlarged size by the first enlargement ratio, in response to a direction key signal. Each of the first image file and the second image file includes a screen nail image having a first resolution and a main image having a second resolution, wherein the first resolution is smaller than the second resolution.

The method may further include: determining a state selected by a first control signal; and when the first control signal selects a first state, moving a display region in the displayed main image of the first image file, in response to the direction key signal, wherein the displaying a second image file is performed when the first control signal has had a second state.

According to another aspect of the present invention, there is provided a digital photographing device including: a first user interface receiving a first control signal; a second user interface receiving a direction key signal; and a display controller, wherein, when the direction key signal is input in a state in which a first image file is enlarged by a first enlargement ratio and the first image file is displayed with enlarged size, in response to the first control signal having a first state, the display controller moves a display region of the first image file, and in response to the first control signal having a second state, the display controller displays a second image file with enlarged size by the first enlargement ratio.

The digital photographing device may further include an image file storage unit that stores at least one image file comprising main image data and screen nail image data, wherein when displaying the first image file or the second image file with enlarged size, the display controller reads and displays main image data of the corresponding image file.

Additionally, the present invention can be embodied as a computer-readable storage medium that stores a computer program. A computer-readable storage medium according to an embodiment of the present invention stores a digital photographing device for controlling a digital photographing device in which at least one set display value is set in a display mode, and the computer program includes: a code portion that is programmed to display a first image file; and a code portion that is programmed to display a second image file in response to a direction key signal while the set display value is maintained.

According to another aspect of the present invention, there is provided a method of controlling a digital photographing device. The method may include displaying a first image according to an enlargement ratio and a display region, wherein the display region indicates which portion of the first image is being displayed; and in response to a selection of a direction key by a user, if a first control signal has a first state, moving the display region according to the selected direction key, and displaying the first image according to the enlargement ratio and the moved display region, and if a first control signal has a second state, displaying a second image according to the enlargement ratio and the display region.

Displaying a first image according to an enlargement ratio and a display region may include displaying a first image according to an enlargement ratio and a display region, and simultaneously displaying a thumbnail image of the first image with the display region in the thumbnail image, wherein the display region indicates which portion of the first image is being displayed.

Displaying the first image according to the enlargement ratio and the moved display region may include displaying the first image according to the enlargement ratio and the moved display region, and simultaneously displaying the thumbnail image of the first image with the moved display region.

Displaying a second image may include displaying a second image according to the enlargement ratio and the display region, and simultaneously displaying a thumbnail image of the second image with the position indication.

According to another aspect of the present invention, there is provided a method of controlling a digital photographing device, the method may include: displaying a first image according to an enlargement ratio and a display region, and simultaneously displaying a thumbnail image of the first image with the display region in the thumbnail image, wherein the display region indicates which portion of the first image is being displayed; and in response to a selection of a direction key by a user, if a first control signal has a first state, moving the display region according to the selected direction key, and displaying the first image according to the enlargement ratio and the moved display region, and simultaneously displaying the thumbnail image of the first image with the moved display region; and if a first control signal has a second state, displaying a second image according to the enlargement ratio and the display region, and simultaneously displaying a thumbnail image of the second image with the position indication.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an example of a digital photographing device;

FIG. 2 is a flowchart illustrating an example of a method of controlling a digital photographing device;

FIG. 3 is a flowchart illustrating an example of a method of controlling a digital photographing device;

FIG. 4 is a schematic view of the structure of an example of an image file generated in a digital photographing device;

FIG. 5 is a diagram illustrating an example of a display unit that displays an image file;

FIG. 6 is a block diagram illustrating an example of the structure of a digital photographing device; and

FIG. 7 is a diagram illustrating an example of an outer shape of a digital photographing device.

### DETAILED DESCRIPTION OF THE INVENTION

Embodiments of the present invention will now be described more fully with reference to the accompanying drawings. The following description and accompanying drawings are presented to understand the operation of the present invention, and some description that may be obvious to those of ordinary skill in the art may not be presented herein.

Also, the present specification and the attached drawings are not intended to limit the present invention and the scope of the present invention should be defined by the claims. All the terms used in the present specification should be interpreted as having a meaning that is consistent with their meaning in the context of the relevant art and will not be interpreted in an idealized or overly formal sense unless expressly so defined herein.

Hereinafter, embodiments of the present invention will be described with reference to the attached drawings.

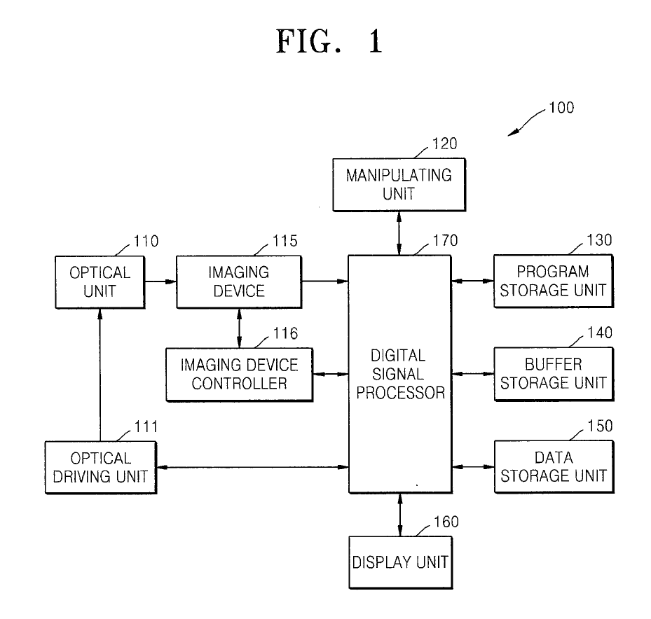

FIG. 1 is a block diagram illustrating an example of a digital photographing device 100. The digital photographing device 100 may include an optical unit 110, an optical driving unit 111, an imaging device 115, an imaging device controller 116, a manipulating unit 120, a program storage unit 130, a buffer storage unit 140, a data storage unit 150, a display unit 160, and a digital signal processor (DSP) 170.

The optical unit 110 transmits an optical signal corresponding to a subject to the imaging device 115. The optical unit 110 may include a zoom lens that is used to increase or decrease an angle of view according to a focal length and a focus lens that is used to focus on a subject. In addition, the optical unit 110 may further include an iris for adjusting the amount of light entering the imaging device 115.

The optical driving unit 111 controls the location of a lens and opening and closing of the iris. By changing the location of the lens, the focus can be adjusted. In addition, by controlling the opening or closing of the iris, the amount of light entering the optical unit 110 can be adjusted. According to a control signal that is automatically generated corresponding to an image signal that is transmitted in real time or a control signal that is generated by manual manipulation of a user, the optical driving unit 111 can control the optical unit 110.

The optical signal passes through the optical unit 110 and reaches a light receiving surface of the imaging device 115, and an image of the subject is formed on the imaging device 115. The imaging device 115 may use a charge coupled device (CCD) or a complementary metal oxide semiconductor image sensor (CIS), each of which may convert the optical signal into an electrical signal. Sensitivity of the imaging device 115 may be controlled by the imaging device controller 116. The imaging device controller 116 may control the imaging device 115 according to the control signal that is automatically generated corresponding to an image signal that is transmitted in real time or the control signal that is generated by manual manipulation of a user.

The manipulating unit 120 is a member through which a user inputs a control signal. The manipulating unit 120 includes a shutter-release button through which a shutter-release signal is input to expose the imaging device 115 to light for a predetermined time period so as to photograph a subject, a power source button for supplying a power source, wide angle-zoom and telescope-zoom buttons for widening or narrowing an angle of view, and various other functional buttons for selecting a mode, such as a text mode, a photographing mode, or a display mode, a white balance setting function, and an exposure setting function. Although the manipulating unit 120 may include various types of buttons as described above, the structure of the manipulating unit 120 is not limited thereto. For example, the manipulating unit 120 may be embodied in any form through which a user may input a desired signal, such as a key board, a touch pad, a touch screen, or a remote controller.

In addition, the digital photographing device 100 includes the program storage unit 130 for storing programs such as an operating system for operating a digital camera or an application system, the buffer storage unit 140 for temporally storing data needed for performing a computing process or result data, and the data storage unit 150 for storing an image file that includes an image signal and various pieces of information needed for the programs.

The digital photographing device 100 includes the display unit 160 for displaying an operation state of the digital photographing device 100 or image information obtained by the digital photographing device 100. The display unit 160 may provide visual information and audible information to a user. To provide visual information, the display unit 160 may include, for example, a liquid crystalline display panel (LCD), and an organic light emitting display panel (OLED).

The digital photographing device 100 also include the digital signal processor 170 for processing input image signals and controlling the respective digital photographing device forming members as described above in correspondence to the input image signals or external input signals.

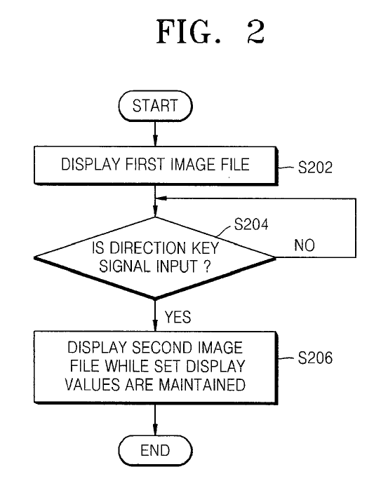

FIG. 2 is a flowchart illustrating an example of a method of controlling a digital photographing device.

According to the example, in a state in which a first image file is displayed, in response to a direction key signal, a second image file is displayed while set display values are maintained.

According to the example, in a display mode, a first image file is displayed (S202). When an image is displayed, a user may select and set at least one display value. The set display value may be, for example, an enlargement ratio, a value with respect to whether a set photographing value is displayed, or an image analysis result.

When a direction key signal is input in a state in which the first image file is displayed (S204), according to the method of controlling a digital photographing device according to the present embodiment, a second image file is displayed while set display values are maintained (S206). For example, if the first image file is displayed with twice enlarged size, in response to a direction key signal input by a user, the second image file is also displayed with the twice enlarged size.

A direction key signal may be a left direction key signal or a right direction key signal. According to the direction of a direction key signal, a previous image file or a next image file can be displayed.

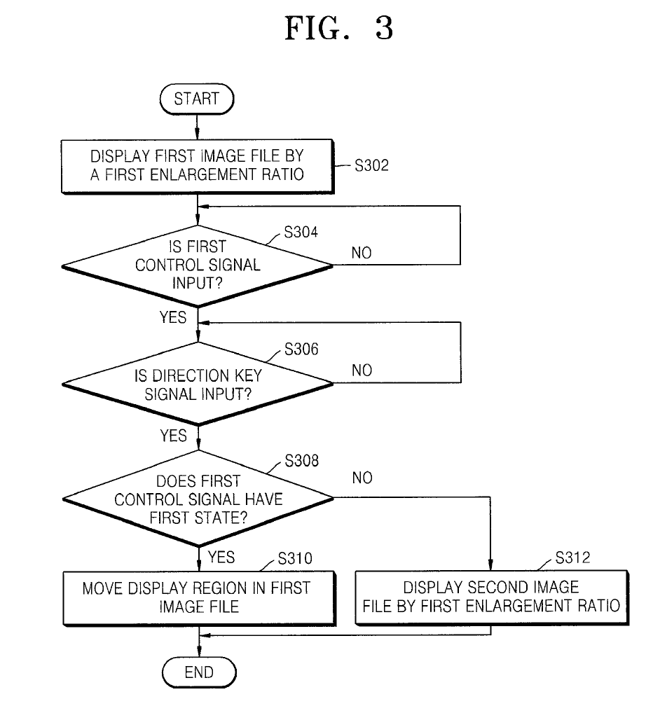

FIG. 3 is a flowchart illustrating an example of a method of controlling a digital photographing device.

According to the example, a user may input a direction key signal to display a second image file while maintaining set display values that are set when a first image file is displayed. In addition, the user may use a separate control signal to either manipulate a display state of the first image file in response to the direction key signal or to display the second image file while the set display values of the first image file are maintained.

According to the example, in correspondence to set display values set by the user, a first image is displayed with enlarged size by a first enlargement ratio (S302). The user may set the first enlargement ratio using a user interface.

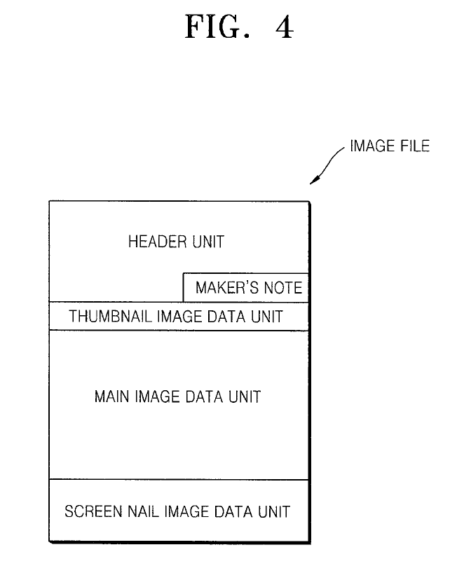

FIG. 4 is a schematic view of an example of the structure of an image file generated in a digital photographing device.

Referring to FIG. 4, the image file includes a header unit, a thumbnail image data unit, a main image data unit, and a screen nail image data unit. The structure of the image file is not limited to the structure illustrated in FIG. 4, and the image file may also have other structures.

The main image data unit includes main image data. The header unit includes data about a manufacturer of a digital image processing device, data about a model name of the digital image processing device, and when the digital image processing device is a digital photographing device, the header unit may further include data about a date on which photographing occurs, data about a shutter speed, and data about iris values or zoom magnification.

The thumbnail image data unit includes thumbnail image data. The thumbnail image is an image formed by contracting a main image stored in main image data unit to show the user a contracted form of the respective images when the user searches for images files.

The screen nail image data unit includes image data that can be used to display an image of a corresponding image file on the display unit 160 of the digital image processing device. Generally, a display unit included in the digital photographing device 100 is small in size and thus it is not necessary that image data stored in the main image data unit, that is, main image data is displayed on the display unit 160. Specifically, the size of data stored in the main image data unit is much larger than data used to display a screen nail image on the display unit 160. Thus, if a screen nail image is displayed on the display unit 160 using data stored in the main image data unit, data process time is increased but the quality of the screen nail image displayed on the display unit 160 may be degraded.

Accordingly, data needed for displaying the screen nail image on the display unit 160 of the digital image processing device is separately present in the image file. The data needed is stored in the screen nail image data unit. Generally, the screen nail image data unit may store image data having a resolution of 640×480 pixels.

The header unit of the image file may also include a maker's note. The maker's note is a place in which records what a maker who designs the structure of the image file wants to record.

According to the example method of controlling the digital photographing device, in a display mode, if the user controls a first image file to be displayed, a screen nail image is read from a screen nail image data unit of the first image file and then displayed. Then, if the user selects that an enlarged image of the first image file is to be displayed, a main image of the first image file is read from a main image data unit of the first image file and then enlarged by an enlargement ratio selected by the user and the enlarged image is displayed.

In a state in which a first image file is displayed with enlarged size by a first enlargement ratio, the user inputs a first control signal to select an operation that is to be performed when inputting a direction key signal (S304).

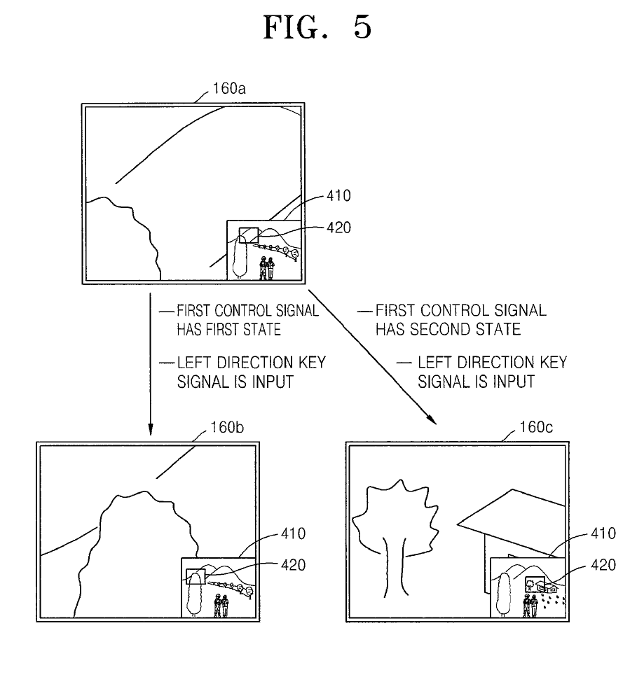

FIG. 5 is a diagram illustrating an example of the display unit 160, which displays an image file.

When an image file is displayed with enlarged size, the display unit 160, as illustrated in FIG. 5, while displaying the enlarged image, displays an entire image file 410 and a display region 420 in a predetermined region of the display unit 160. The display region 420 illustrates a portion of the entire image file corresponding to the currently displayed image.

In a state 160a of FIG. 5 in which a first image file is displayed with enlarged size, the user inputs a direction key signal to move the display region 420 or to display a second image file. To do either of these, the user inputs a first control signal to select a desired operation.

In the example method of controlling a digital photographing device, when a direction key signal is input (S306), a state of the first control signal is determined (S308). If the first control signal has a first state, in response to the direction key signal, the display region 420 of the first image file is moved according to the direction key signal (S310). For example, if a left direction key signal is input, the display region 420 is moved toward the left, a portion of the main image corresponding to the moved display region 420 is enlarged and the enlarged image is displayed on the display unit 160, as in a state 160b of FIG. 5.

If the first control signal selected a second state, in response to the direction key signal, the second image file is displayed with enlarged size by a first enlargement ratio and the enlarged second image file is displayed (S312). For example, if image files are arranged according to a file name, when a left direction key signal is input, an image file prior to the first image file is displayed with enlarged size by the first enlargement ratio, and when a right direction key signal is input, an image file following the first image file is displayed with enlarged size by the first enlargement ratio. For example, if the first control signal has the second state, when a direction key signal is input, a second image is displayed while an enlargement ratio and a location of the display region 420 set in a first image file are maintained, as in a state 160c,

If a first control signal is not input, a predetermined operation may be performed. For example, if a first control signal is not input, in response to a direction key signal, a second image file may be displayed in a first enlargement ratio.

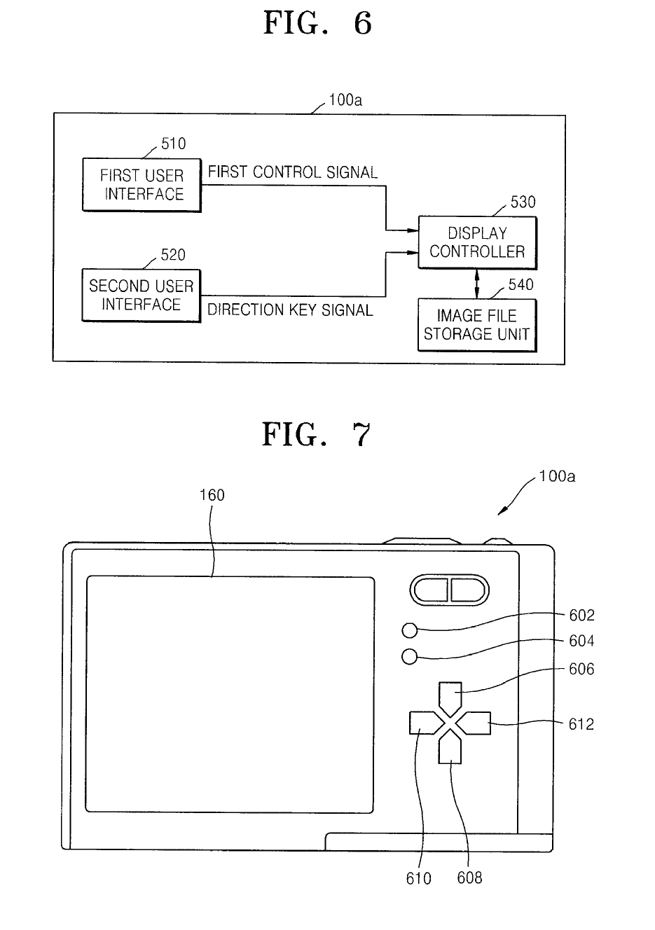

FIG. 6 is a block diagram illustrating the structure of an example of a digital photographing device 100a.

The digital photographing device 100a provides a separate user interface for inputting a first control signal to select whether the display region 420 of a first image file is moved or a second image file is displayed with enlarged size of the first image file, in response to a direction key signal input by the user when an enlarged first image file is displayed.

The digital photographing device 100a includes a first user interface 510, a second user interface 520, a display controller 530, and an image file storage unit 540.

Through the first user interface 510, the user may input a first control signal. The first control signal may have a first state or a second state. In this regard, the first state is a state in which the display region 420 of a first image file is moved in response to a direction key signal input by the user in a state in which the first image file is displayed in a first enlargement ratio, and the second state is a state in which a second image file is displayed with enlarged size by the first enlargement ratio in response to a direction key signal input by the user.

Through the second user interface 520, the user may use direction keys to display a previous image file or a next image file with a default enlargement ratio.

FIG. 7 is a diagram illustrating an example of an outer shape of the digital photographing device 100a according to an embodiment of the present invention.

Referring to FIG. 7, the digital photographing device 100a may include a display unit 160, manipulation keys 602 and 604, and direction keys 606, 608, 610, and 612. According to another example, the first user interface 510 may be realized by using any one of the manipulation keys 602 and 604 and software that provides a user interface screen to the display unit 160. In addition, the manipulation keys 602 and 604 may be formed in a housing of the digital photographing device 100a as illustrated in FIG. 7 or may be implemented as icons on a touch screen.

Through the second user interface 520, the user inputs a direction key signal. The user may input a direction key signal corresponding to a desired direction. According to the example, the second user interface 520 may be realized using at least one direction key selected from among the direction keys 606, 608, 610, and 612 and software for providing a user interface screen to the display unit 160. In addition, the direction keys 606, 608, 610, and 612 may be formed in the housing of the digital photographing device 100a as illustrated in FIG. 7 or may be implemented as icons on a touch screen.

In a state in which a first image file is displayed in a first enlargement ratio, the digital photographing device 100a can be controlled in the following way. When a first control signal has the first state, the user can move the display region 420 in a desired direction by using the direction keys 606, 608, 610, and 612. When the first control signal has the second state, the user uses the direction keys 606, 608, 610, and 612 to display a previous image file or a next image file by the first enlargement ratio.

In a state in which a first image file is displayed in a first enlargement ratio, when a direction key signal is input, when a first control signal has the first state, the display controller 530 controls the display region of the first image file to be moved, and when the first control signal has the second state, the display controller 530 controls a second image file to be displayed with enlarged size by the first enlargement ratio. For example, the display controller 530 may operate in the same manner as having been described with reference to FIG. 5. The display controller 530 may be realized using, for example, the program storage unit 130, which stores a computer program for performing an operation of the display controller 530, and the digital signal processor 170, which reads and executes the computer program.

If a first control signal is not input, the display controller 530 may perform a predetermined operation. For example, if a first control signal is not input, in response to a direction key signal, the display controller 530 displays a second image file with enlarged size by a first enlargement ratio. The first enlargement ratio may be a default enlargement ratio shipped with the digital image processing device.

The image file storage unit 540 stores at least one image file. The at least one image file includes a main image data unit and a screen nail image data unit. For example, the at least one image file may have the file structure illustrated in FIG. 4. The image file storage unit 540 may be, for example, the data storage unit 150.

Additionally, the present invention can be embodied by storing a computer readable code on a computer-readable storage medium. The computer-readable storage medium can be a physical storage device that stores computer system readable data.

When the digital signal processor 170 reads the computer-readable code stored in the computer-readable storage medium and the computer-readable code is executed, the computer-readable code implements operations that form the methods of controlling a digital photographing device according to the above embodiments of the present invention. The computer-readable code may be realized in various programming languages. In addition, functional programs, codes, and code segments that are used to realize the present invention may be easily programmed by those of ordinary skill in the art.

Examples of the computer-readable storage medium include ROMs, RAMs, CD-ROMs, magnetic tapes, floppy disks, and optical data storage devices. Furthermore, the computer-readable storage medium may also be a distributed network, so that the computer readable code is stored/transferred and executed in a distributed fashion.

According to the above embodiments of the present invention, in a display mode, even when a user inputs a direction key signal to display a previous or next image file, set display values are maintained. Thus, the user can display the previous or next image file with desired set display values without re-setting set display values in the previous or next image file.

In addition, a user selectable control signal is input by the user so that the user selects an operation of displaying a previous or next image file in response to a direction key signal input by the user while currently set display values are maintained or an operation of manipulating a display state of the currently displayed image file. Thus, convenience of the user can be increased.

For convenience, in the description above, the functionality described has been divided into a number of units; however, the number of units may vary and the functionality described above may be differently divided among the units, or the functionality described above may be implemented without units.

The various illustrative units described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. While the present invention has been particularly shown and described with reference to exemplary embodiments thereof, it will be understood by those of ordinary skill in the art that various changes in form and details may be made therein without departing from the spirit and scope of the present invention as defined by the following claims.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A method of controlling a digital photographing device capable of setting at least one set display value in a display mode, the method comprising:
displaying a first image file; and
displaying a second image file while the set display value is maintained, in response to a direction key signal.

2. The method of claim 1, wherein
the set display value is an enlargement ratio by which an image file is displayed with enlarged size,
wherein the displaying a first image file displays the first image file with the enlarged size by a first enlargement ration, and
the displaying a second image file displays the second image file with the enlarged size by the first enlargement ratio.

3. The method of claim 2, further comprising
determining a state selected by a first control signal; and
when the first control signal has a first state, moving a display region in the displayed first image file with the enlarged size, in response to the direction key signal,
the displaying a second image file is performed when the first control signal has had a second state.

4. A method of controlling a digital photographing device, the method comprising:
displaying a main image of a first image file with enlarged size by a first enlargement ratio; and
displaying a main image of a second image file with enlarged size by the first enlargement ratio, in response to a direction key signal.

5. The method of claim 4, wherein each of the first image file and the second image file comprises a screen nail image having a first resolution and a main image having a second resolution, wherein the first resolution is smaller than the second resolution.

6. The method of claim 5, further comprising:
determining a state selected by a first control signal; and
when the first control signal selects a first state, moving a display region in the displayed main image of the first image file, in response to the direction key signal,
wherein the displaying a second image file is performed when the first control signal has had a second state.

7. A digital photographing device comprising:
a first user interface receiving a first control signal;
a second user interface receiving a direction key signal; and
a display controller, wherein the display controller is configured to: when the direction key signal is input in a state in which a first image file is enlarged by a first enlargement ratio and the first image file is displayed with enlarged size,
in response to the first control signal having a first state, the display controller moves a display region of the first image file, and
in response to the first control signal having a second state, the display controller displays a second image file with enlarged size by the first enlargement ratio.

8. The digital photographing device of claim 7, further comprising an image file storage unit that stores at least one image file comprising main image data and screen nail image data,
wherein when displaying the first image file or the second image file with enlarged size, the display controller reads and displays main image data of the corresponding image file.

9. A computer-readable storage medium storing a computer program for controlling a digital photographing device in which at least one set display value is set in a display mode, the computer program comprising:
a code portion that is programmed to display a first image file; and
a code portion that is programmed to display a second image file in response to a direction key signal while the set display value is maintained.

10. The computer-readable storage medium of claim 9, wherein the display set value is an image enlargement ratio by which an image file is displayed with enlarged size,
wherein the code portion that is programmed to display the first image file is programmed to display the first image file with the enlarged size by a first enlargement ratio, and
the code portion that is programmed to display the second image file is programmed to display the second image file with the enlarged size by the first enlargement ratio.

11. The computer-readable storage medium of claim 10, wherein the computer program further comprises:
a code portion that is programmed to determine a state selected by a first control signal; and
a code portion that is programmed to move a display region in the displayed first image file with the enlarged size in response to the direction key signal when the first control signal has had a first state,
wherein the code portion that is programmed to display the second image file is executed when the first control signal has had a second state.

12. A computer-readable storage medium storing a computer program, wherein the computer program comprises:
a code portion that is programmed to display a main image of a first image file with enlarged size by a first enlargement ratio; and
a code portion that is programmed to display a main image of a second image file with enlarged size by the first enlargement ratio in response to a direction key signal.

13. The computer-readable storage medium of claim 12, wherein each of the first image file and the second image file comprises a screen nail image having a first resolution and a main image having a second resolution, wherein the first resolution is smaller than the second resolution.

14. The computer-readable storage medium of claim 13, wherein the computer program further comprises:
a code portion that is programmed to determine a state selected by a first control signal; and
a code portion that is programmed to move a display region in the displayed first image file in response to the direction key signal when the first control signal has had a first state,
wherein the code portion that is programmed to display the second image file is executed when the first control signal has had a second state.

15. A method of controlling a digital photographing device, the method comprising:
displaying a first image according to an enlargement ratio and a display region, wherein the display region indicates which portion of the first image is being displayed;
in response to a selection of a direction key by a user,
if a first control signal has a first state, moving the display region according to the selected direction key, and displaying the first image according to the enlargement ratio and the moved display region, and
if a first control signal has a second state, displaying a second image according to the enlargement ratio and the display region.

16. The method of claim 15, wherein
displaying a first image according to an enlargement ratio and a display region, further comprises:
displaying a first image according to an enlargement ratio and a display region, and simultaneously displaying a thumbnail image of the first image with the display region in the thumbnail image, wherein the display region indicates which portion of the first image is being displayed;
displaying the first image according to the enlargement ratio and the moved display region, further comprises:
displaying the first image according to the enlargement ratio and the moved display region, and simultaneously displaying the thumbnail image of the first image with the moved display region; and
displaying a second image, further comprises:
displaying a second image according to the enlargement ratio and the display region, and simultaneously displaying a thumbnail image of the second image with the position indication.

17. A method of controlling a digital photographing device, the method comprising:
displaying a first image according to an enlargement ratio and a display region, and simultaneously displaying a thumbnail image of the first image with the display region in the thumbnail image, wherein the display region indicates which portion of the first image is being displayed;
in response to a selection of a direction key by a user,
if a first control signal has a first state, moving the display region according to the selected direction key, and displaying the first image according to the enlargement ratio and the moved display region, and simultaneously displaying the thumbnail image of the first image with the moved display region; and
if a first control signal has a second state, displaying a second image according to the enlargement ratio and the display region, and simultaneously displaying a thumbnail image of the second image with the position indication.
